(19) United States
(12) Patent Application Publication
(10) Pub. No.: US 2011/0049775 A1
(43) Pub. Date: Mar. 3, 2011

(54) Boat shock absorption system

(76) Inventor: David Neal Crumley, San Marcos, TX (US)

(21) Appl. No.: 12/805,974

(22) Filed: Aug. 26, 2010

Related U.S. Application Data
(60) Provisional application No. 61/238,746, filed on Sep. 1, 2009.

(51) Int. Cl. F16F 7/00; F16F 3/04

(52) U.S. Cl. 267/136

(57) ABSTRACT

A Boat Shock Absorption System for absorbing the shock caused by waves and wakes of other boats is shown. The invention is comprised of a lower portion that includes springs and plates. In the preferred embodiment, this lower portion is attached to an upper portion containing a cooler retaining ring. A cooler can be inserted into the cooler retaining ring and used as a seat for passengers. Additionally, the lower portion of the System can be attached underneath any platform that is stood on or sat on by passengers or operators of the boat.

### BACKGROUND OF THE INVENTION

1. Field of the Invention

The present invention relates generally to a Boat Shock Absorption System (“System”) for providing shock absorption and cushioning while riding in or driving a boat, which encounters impact with waves in the water or wakes from other boats that cause the boat to pound. The present invention relates more specifically to a System that an ice cooler ring can be inserted into for riders to sit on or that a driver can place under a platform to stand on while driving the boat. The System absorbs the shock the boat encounters from the waves in the water and wakes from other boats.

2. Objects of the Invention

A primary object and feature of this invention is to provide comfort to those sitting on the coolers in the boat when the boat hits waves or wakes of other boats.

Additionally, it is an object and feature of the present invention to provide comfort to the driver standing and operating the boat when the boat hits waves or wakes of other boats.

A further object and feature of the present invention is to provide comfort to anyone sitting or standing on the boat by placing the lower portion of the System underneath a seat or standing platform.

It is further an object and feature of the present invention that all components of the System be made out of aluminum or stainless steel to prevent rust.

It is further an object and feature of the present invention that the system be easy to install on a wide variety of boats without causing damage or physical modification to the boat. Additionally, it is an object and feature of the present invention that the system provides these features effectively in an inexpensive form, without complicated instructions or extensive time required to set up or remove.

### SUMMARY OF THE INVENTION

The above and other objectives and features are archived through the use of a novel System herein disclosed. In accordance with a preferred embodiment of the present invention, the System as provided comprises a lower portion and an upper portion that could contain a cooler ring. The upper portion could also be any apparatus desired for sitting or standing on inside the boat. The lower portion contains upper and lower plates and two side supports. Preferably, there are springs between the two plates of the lower portion, and the springs are spaced evenly along the plates and welded between the plates. The upper portion of the System may contain a cooler retaining ring, which will be sized to fit the cooler desired for use and will have posts and a plate for affixing the upper portion to the lower portion. The upper portion is bolted to the lower portion of the System using bolts and nuts. It is preferred that all material used to construct the System be aluminum or stainless steel to prevent rusting.

It is to be understood that the invention is not limited in its application to these details and construction, the arrangement of components stated herein or in the drawings, or strictly the uses described. The invention is capable of different embodiments and being used in other ways, including but not limited to affixing the lower portion underneath a platform for the driver to stand on while operating the boat. The terms used herein are for descriptive purposes only, and should not be regarded as limiting. As such, those skilled in the art will appreciate that the other structures and methods for carrying out the listed purposes of the invention. Therefore, the invention is not limited to the exact embodiment herein illustrated and described, and accordingly, all appropriate modifications and equivalents may fall within the scope of the invention.

### BRIEF DESCRIPTION OF THE DRAWINGS

FIG. 1 is a side view of a boat encountering impacts with waves and/or wakes of other boats with the driver standing in the boat and the passenger sitting in the boat, both feeling the Impact of the waves and/or wakes of other boats.

FIG. 2 is a cross-sectional side view of the preferred form of the System sitting on the floor of a boat with a cooler inside the cooler retaining ring.

FIG. 3 is an exploded perspective view of the preferred form of the System illustrating the upper and lower portions that are bolted together and also showing where the cooler is inserted.

FIG. 4 is a top view of the preferred form of the System illustrating the springs and side supports.

FIG. 5 is an elevated, partially sectioned, side view of the preferred form of the System showing how the cooler retaining ring is affixed to the upper plate of the lower portion.

### DETAILED DESCRIPTION OF A FIRST PREFERRED EMBODIMENT

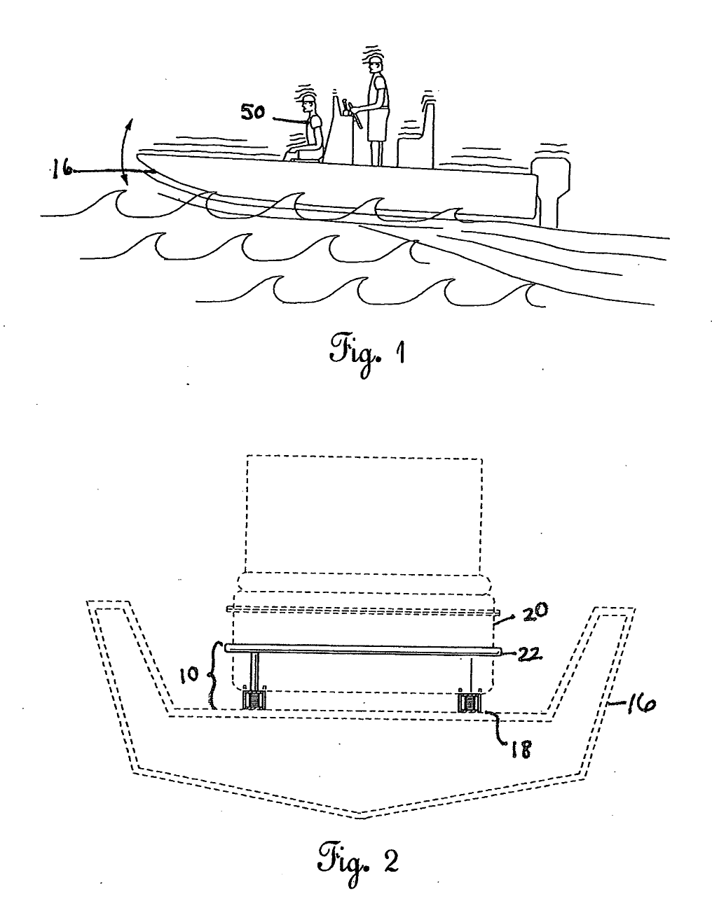

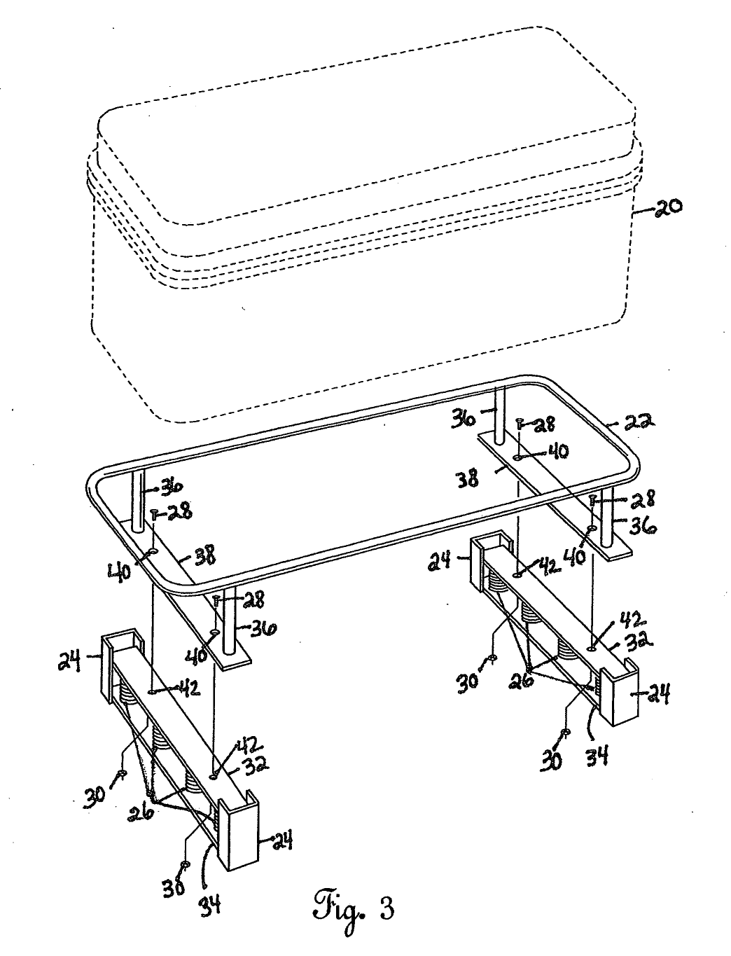

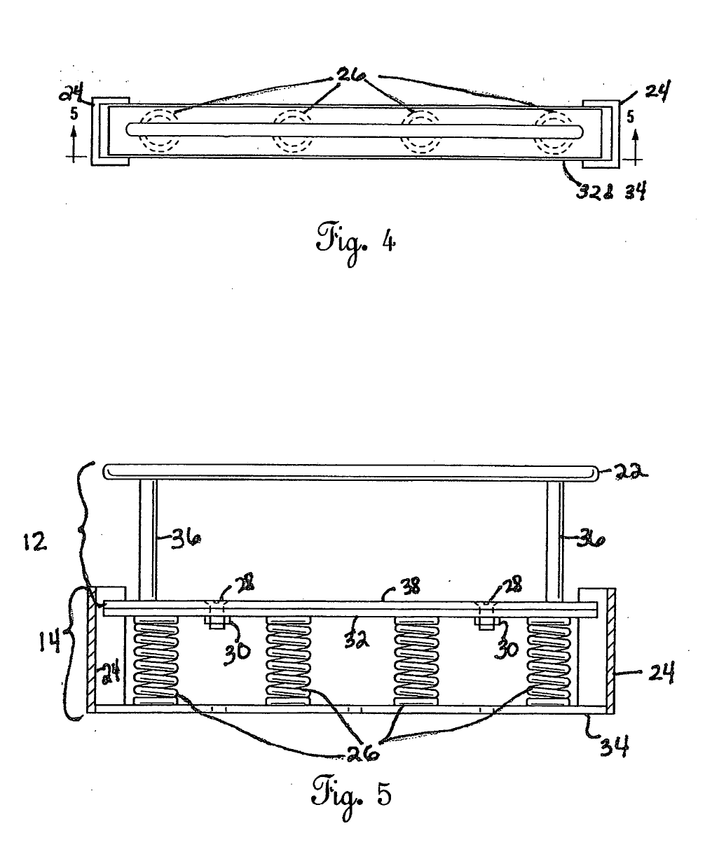

As illustrated in FIG. 2, a first preferred embodiment of the present invention describes a System 10 that is used for placement of a cooler 20 inside a cooler retaining ring 22. The cooler 20 acts as a seat for passengers on a boat, and the System 10 underneath the cooler 20 absorbs the shock from waves or wakes from other boats. As shown in FIG. 1, the passenger 50 sitting inside the boat 16 is being pounded from the waves and wakes of other boats. FIG. 2 illustrates, in general, the System 10 sitting in a boat 16 on the floor 18 with a cooler 20 placed inside the cooler retaining ring 22.

The System 10, as illustrated in FIGS. 3 & 5, includes a lower portion 14 and an upper portion 12. The lower portion 14 as illustrated in FIG. 3 is a comprised of an upper plate 32 and a lower plate 34. The plates are attached together using four evenly spaced springs 26.

As shown in FIGS. 3 & 4, the lower plate 34 has side supports 24 affixed to them, which allow the upper plates 32 to move up and down as the springs 26 are compromised and released. As shown in FIG. 3, each upper plate 32 has two upper plate holes 42 for use in affixing the upper portion 12 to the lower portion 14. The upper portion 12, as illustrated in FIG. 3, contains a cooler retaining ring 22, which is designed to fit around the perimeter of the cooler 20 desired for use as a seat on the boat. As shown in FIG. 3, the cooler retaining ring 22 is affixed to four posts 36, two on each end. The posts 36 are then connected to the cooler retaining ring plates 38, one on each side. Each cooler retaining plate 38 is connected to two cooler retaining posts 36. Each cooler retaining plate 38 has two cooler retaining ring plate holes 40 for use in affixing the upper portion 12 to the lower portion 14.

FIG. 3 illustrates how the upper portion 14 is bolted to the lower portion 12 using four bolts 28 and four nuts 30, two on each end. The bolts 28 are placed facing down through the cooler retaining ring plate 38 and then into the upper plate holes 42 of the lower portion 14 of the System 10. As illustrated in FIGS. 3 & 5, nuts 30 are placed underneath the upper plate 32 of the lower portion 14 and screwed into the bolts 28 to keep the bolts in place. FIG. 5 shows the upper portion 12 and lower portion 14 connected via the bolts 28 and nuts 30. The cooler retaining ring plate 38 is then directly on top of the upper plate 32. FIG. 5 also illustrates the side supports 24 connected to the lower plate 34 and the spacing of the springs 26 welded between the upper plate 32 and lower plate 34. FIG. 5 shows the cooler retaining ring posts 36 connected to the cooler retaining ring 22 and the cooler retaining ring plate 38.

The System 10 can be placed anywhere on a boat floor 18 (see FIG. 2) and the cooler 20 is inserted into the System 10 within the cooler retaining ring 22. A boat passenger 50 can sit on the cooler 20, and the shock from waves or wakes of other boats will be absorbed. All material in the System 10 must be aluminum or stainless steel to prevent rusting. This preferred embodiment would have the advantage of eliminating much of the impact and discomfort a boat passenger feels when the boat hits waves or wakes from other boats. Because people will be sitting on the coolers 20, it is preferred that the springs 26 used have a compression for up to 650 pounds.

### DETAILED DESCRIPTION OF ALTERNATE PREFERRED EMBODIMENTS

Various modifications of the above described basic concept are also anticipated. It may be desirable to place the lower portion 14 of the System 10 (as illustrated in FIGS. 3 and 5) underneath a type of platform that the driver can stand on while operating the boat. Such an embodiment would have the advantage of eliminating the impacts a driver will encounter when the boat hits waves and wakes of other boats as he/she is trying to operate the boat. Such an embodiment for use under a platform could be established by building only the lower portion 14 of the System 10 and not attaching the upper portion 12 containing the cooler retaining ring 22, but instead attaching the lower portion 14 of the System 10 to a type of platform that can be used to stand on while operating the boat. A wooden board or other material could be used as the platform.

Other embodiments are anticipated including placing the lower portion 14 of the System 10 under any type of seat on the boat or any apparatus that can be stood on by a passenger or driver. This may include, but is not limited to, a leaning post or the platform the passengers stand on while riding in the boat.

It is to be understood that the inventions are not limited to the exact construction or method illustrated, but that various changes and/or modifications may be made without departing from the spirit or scope of the inventions as more fully described in this application.

I claim:

1. A shock absorber assembly that will give comfort to boat passengers when encountering waves or wakes of other boats. The assembly consist of an upper plate and lower plate with springs supporting the plates. The bottom plate has a cee channel welded on each end. The springs are then welded to the bottom plate. A top plate sits on top of the springs and rides in the cee channel allowing the top plate to move up and down as the springs are compressed, absorbing shock. All materials used are aluminum, stainless or corrosion resistance.

2. An assembly as claimed in claim 1 is then bolted under a cooler ring, then attached to the boat deck and a cooler is then placed in the cooler ring. The passenger riding on top of the assembly allows the springs to compress. When the boat encounters waves the springs absorb the shock for passengers sitting on the cooler.

3. An assembly as claimed in claim 1 may also be bolted under a board or platform to allow the boat driver to stand on while driving the boat to absorb the wave shock.
